(19) United States
(12) Patent Application Publication
(10) Pub. No.: US 2003/0024724 A1
(43) Pub. Date: Feb. 6, 2003

(54) Alternative orientation for a grounded electrical receptacle

(76) Inventor: Simeon Leifer, Cupertino, CA (US)

Correspondence Address: Intellectual Arts, 26 Fell Street, San Francisco, CA, 94102, US

(21) Appl. No.: 09/922,506

(22) Filed: Aug. 3, 2001

(51) Int. Cl. H01H 9/02

(52) U.S. Cl. 174/53

(57) ABSTRACT

A method and apparatus to accommodate multiple electrical transformer plug assemblies, or “brick” assembly plugs, is described, intended to enable space-efficient placement of brick assembly plugs and other over-sized electrical plug assemblies into a standard commercial or residential electrical outlet form factor. It is a further goal of the invention to enable an adaptive solution for interfacing multiple brick assembly plugs and other over-sized electrical plug assemblies to standard commercial or residential electrical outlets.

### FIELD OF THE INVENTION

The invention described herein relates to the field of commercial/residential electrical receptacles. More particularly, the invention relates to an interface between electrical plugs of various sizes and commercial/residential electrical wall outlets.

### BACKGROUND

Standard electrical wall outlets found in most commercial and residential properties typically contain receptacles that are oriented to accomodate two standard 3-prong electrical plug assemblies. Furthermore, electrical adapter accessories such as bar assemblies and plug-in adapters are similarly configured to accommodate mainly standard 3-prong electrical plug terminals.

Although electrical adapter accessories and standard electrical wall outlets may accommodate one or more electrical transformer plug assemblies (“brick” plug assemblies), one may have to manipulate the position of the brick plug assembly in order to fit multiple brick plug assemblies or a brick assembly and other standard 3-prong electrical plug terminals within the same outlet or adapter.

In the case of a standard two-receptacle electrical wall outlet, only one brick plug assembly may be plugged in at any given time, because the receptacles are oriented in the same direction insofar as the female ground receptacles are located on the same side of the positive and negative female receptacle pair to which they correspond. Therefore, it is impossible to plug in two brick plug assemblies into a standard two-receptacle, three-prong wall outlet. This is also true of standard two-receptacle, two-prong wall outlets.

In the case of an electrical adapter accessory, such as a bar assembly or plug-in adapter, one may plug in more than one brick plug assembly, but doing so often covers at least a portion of neighboring receptacles making it impossible to use the neighboring receptacles for another brick plug assembly or standard two- or three-prong electrical plug assemblies.

As a result, one is either unable to plug in two brick plug assemblies into a standard electrical wall outlet or unable to use all receptacles within an adaptive accessory, such as bar assembly or plug-in adapter.

### DESCRIPTION OF THE DRAWINGS

The features and advantages will become apparent from the following detailed description in which:

FIG. 1 illustrates a standard electrical wall outlet.

FIGS. 2a and 2b illustrate electrical adapter accessories.

FIG. 3a illustrates a standard three-prong electrical plug assembly in accordance with one embodiment.

FIG. 3b illustrates an electrical transformer plug assembly in accordance with one embodiment.

FIG. 4 illustrates an electrical wall outlet containing two receptacles according to one embodiment.

FIG. 5a illustrates an electrical wall outlet containing four receptacles according to one embodiment.

FIG. 5b illustrates an electrical wall outlet containing four receptacles according to one embodiment.

FIG. 6 illustrates an electrical adapter assembly according to one embodiment.

### DETAILED DESCRIPTION

A method and apparatus to accommodate multiple electrical transformer plug assemblies, or “brick” assembly plugs, is described, intended to enable space-efficient placement of brick assembly plugs and other over-sized electrical plug assemblies into a standard commercial or residential electrical outlet form factor. It is a further goal of the invention to enable an adaptive solution for interfacing multiple brick assembly plugs and other over-sized electrical plug assemblies to standard commercial or residential electrical outlets.

Typical Electrical Outlets and Adapters

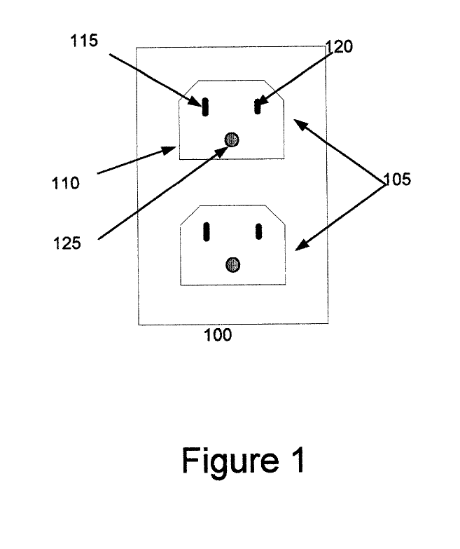

FIG. 1 illustrates a standard electrical wall outlet. An electrical wall outlet 100 typically consists of two electrical receptacles 105 containing two or three female terminals. Three-prong electrical receptacles 110 typically consist of a positive female terminal 115, a negative female terminal 120, and a ground female terminal 125.

A typical application of a standard electrical wall outlet involves a user plugging in either up to two standard two- or three-prong plug assemblies or one standard two- or three-prong plug assembly and one over-sized electrical plug assembly, such as a brick plug assembly.

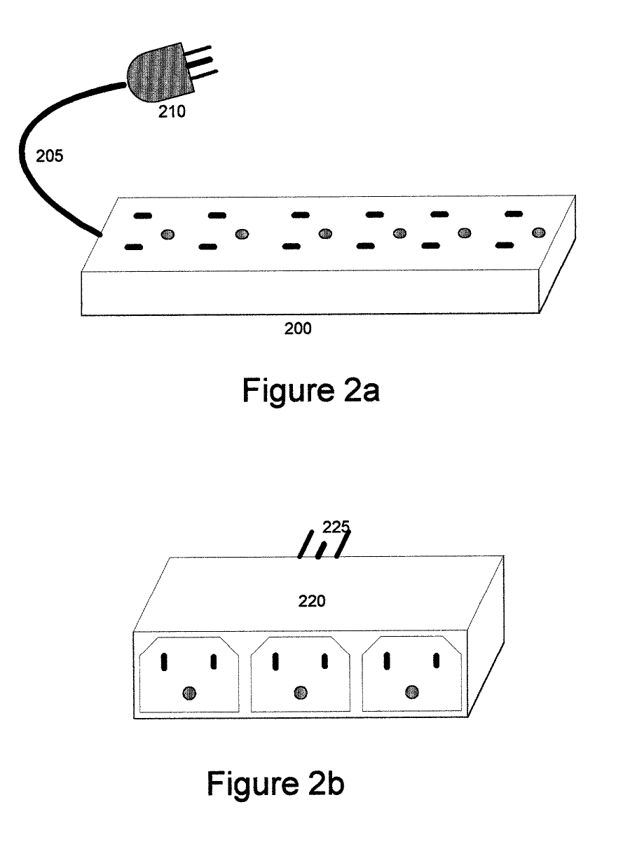

FIG. 2a illustrates “bar” receptacle assembly. A “bar” assembly 200 is capable of accomodating a number of standard plug assemblies or brick plug assemblies. The bar assembly makes electrical contact with an electrical outlet via an electrical cord 205, at one end of which is a standard two or three-prong electrical plug assembly 210.

FIG. 2b illustrates a “plug-in” adapter assembly 220 that is capable of accomodating multiple two- or three-prong standard plug assemblies or one or more brick plug assemblies, depending on the number of receptacles within the adapter. The “plug-in” adapter assembly illustrated in FIG. 2b electrically engages with an electrical outlet via a standard two- or three-prong male plug assembly 225 connected to one side of the adapter assembly.

Two Types of Electrical Plug Assemblies

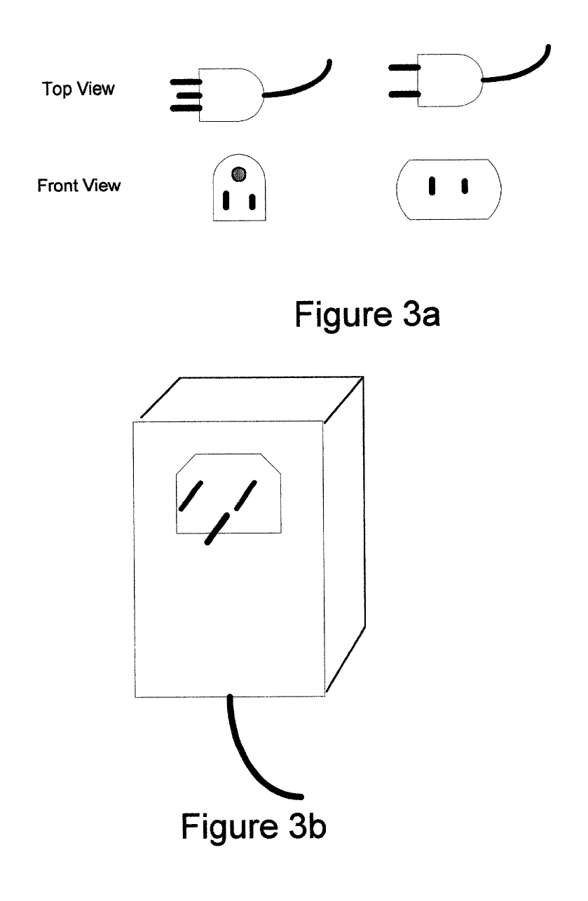

FIGS. 3a and 3b illustrate a standard three-prong electrical plug assembly 300 and an electrical transformer plug assembly 305, or “brick” assembly, in accordance with one embodiment. Each electrical plug assembly illustrated uses a standard two or three male prong plug arrangement 310 intended to be electrically engaged with, or “plugged into”, a receptacle of an electrical outlet consistent with those illustrated in FIGS. 1 and 2.

Currently, only one brick plug assembly may occupy a receptacle of a standard wall outlet due to the orientation of the receptacles of the wall outlet. Although more than one brick plug assembly can occupy a receptacle in adapter accessories, such as bar assemblies and plug-in adapters, it is typically at the expense of lost receptacle usage due to the brick plug assembly encroaching on neighboring receptacles within the adapter accessory. It is, therefore, desireable to accomodate brick plug assemblies efficiently in standard wall outlets while remaining consistent with standard wall outlet form factors.

An Improved Electrical Outlet

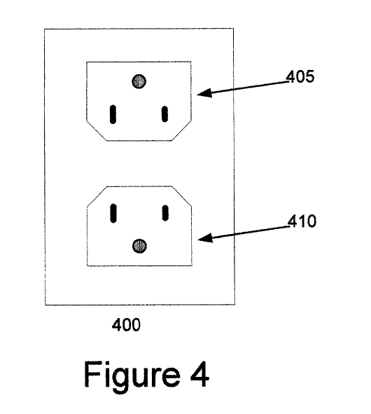

FIG. 4 illustrates a wall-mounted electrical outlet according to one embodiment. The wall outlet 400 illustrated in FIG. 4 may have a standard wall outlet form factor while acccommodating two brick plug assemblies at once by rotating one receptacle 405 of the wall outlet by 180 degrees such that it is oriented in an opposite direction of the other receptacle 410.

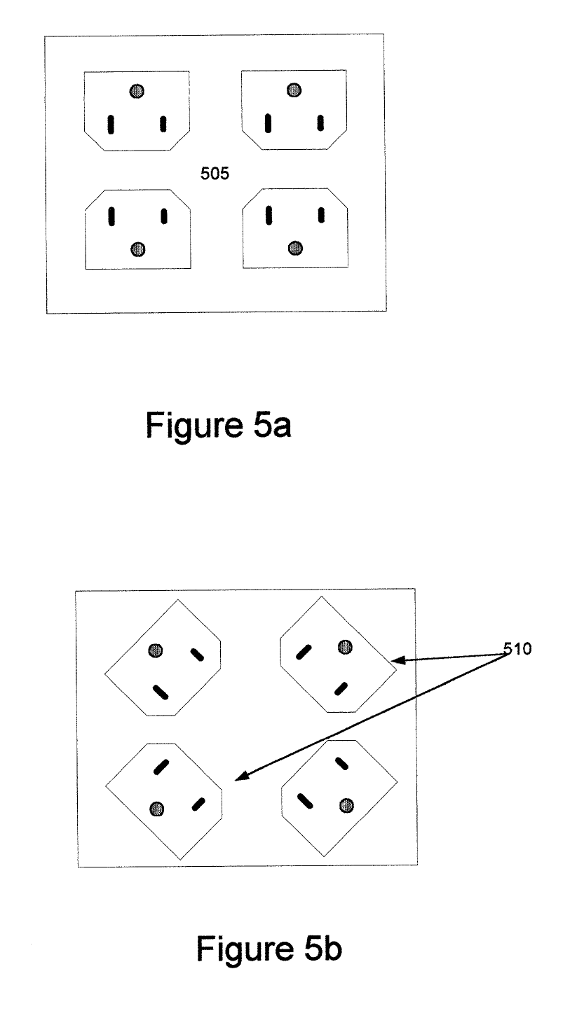

Furthermore, a wall outlet with more than two receptacles may accomodate a brick plug assembly in each receptacle. FIG. 5a and 5b illustrates an electrical wall outlet 500 containing four receptacles according to one embodiment.

In one embodiment, a wall outlet may contain four receptacles while accomodating multiple brick assembly plugs within a standard four-receptacle wall outlet form factor by orienting each receptacle such that each respective female ground terminal occupies an area outside of an area between the receptacles 505. Orienting the receptacles with their respective female ground terminal outside of an area between the receptacles enables a brick plug assembly to occupy each receptacle at the same time.

In one embodiment, a wall outlet containing four receptacles contains receptacles positioned such that each receptacle is oriented in an opposite direction of another receptacle 510. Orienting each of the four receptacles to be in an opposite direction of at least one other receptacle enables a brick plug assembly to be engaged with each of the four receptacles at once while allowing the receptacles to be contained within a standard wall outlet form factor.

Although embodiments containing two and four receptacles, respectively, have been described, other embodiments may accommodate more or fewer brick plug assemblies.

Furthermore, while embodiments have been described in which a brick plug assembly contains a male ground terminal, other embodiments exist in which multiple brick assembly plugs may be accomodated simultaneously that do not contain a male ground terminal.

An Adapter Assembly

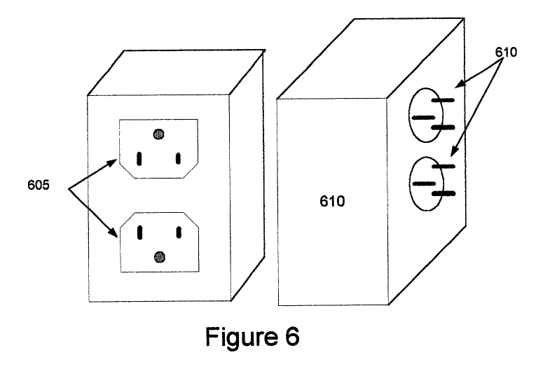

In order to accommodate multiple brick plug assemblies within existing standard wall outlets, a multi-receptacle adapter assembly may be desireable. FIG. 6 illustrates one embodiment in which multiple brick plug assemblies may be interfaced to a standard two-receptacle wall outlet form factor by connecting the brick plug assemblies to the two-receptacle wall outlet through an adapter assembly.

Consistent with other embodiments, the adapter assembly of FIG. 6 contains two receptacles 600 oriented such that the female ground terminals are located outside of an area between the receptacles. Furthermore, FIG. 6 illustrates an embodiment in which the receptacles are oriented in opposite directions of each other.

The adapter of FIG. 6 also contains male terminals 605 on the opposite side of the housing 610 from the receptacles. The male terminals are positioned and oriented such that they may be electrically engaged with standard wall outlet receptacles.

Furthermore, the housing may electrically isolate the male terminals, receptacles, or any other structure connecting the male terminals with the receptacles within the housing so as to be compliant with common industry safety standards, such as those defined by the Underwriter Laboratories (UL).

While this invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

What is claimed:

1. An apparatus comprising:
a plurality of electrical receptacles, each of said plurality of electrical receptacles comprising a female positive and negative terminal pair and at least one female ground terminal, said plurality of said electrical receptacles being oriented such that each of said at least one female ground terminal is located outside of an area between said female positive and negative terminal pairs of said plurality of electrical receptacles.

2. The apparatus of claim 1 wherein said plurality of receptacles are oriented so as to enable a brick plug assembly to be electrically engaged with each of said plurality of receptacles at once.

3. The apparatus of claim 2 wherein said electrical receptacles fit within a standard commercial or residential wall electrical outlet form factor.

4. The apparatus of claim 3 wherein at least two of said plurality of electrical receptacles are oriented in opposite directions of each other.

5. An apparatus comprising:
a plurality of electrical receptacles, each of said plurality of electrical receptacles comprising a female positive and negative terminal pair and at least one female ground terminal, said plurality of said electrical receptacles being oriented such that each of said at least one female ground terminals is located outside of an area between said female positive and negative terminal pairs of said plurality of electrical receptacles.
an adaptive interface being enabled to electrically engage a standard commercial or residential electrical outlet.

6. The apparatus of claim 5 further comprising a housing, said housing enabled to electrically isolate said plurality of receptacles and said adaptive interface such that said apparatus is compliant with common consumer or commercial safety standards.

7. The apparatus of claim 6 wherein said adaptive interface is positioned on an opposite side of said housing from said plurality of receptacles so as to enable said plurality of receptacles to be electrically engaged with at least one electrical plug assembly when said adaptive interface is electrically engaged with said standard commercial or residential electrical outlet.

8. The apparatus of claim 5 wherein said plurality of receptacles are oriented so as to enable a brick plug assembly to be electrically engaged with each of said plurality of electrical receptacles at once.

9. The apparatus of claim 8 wherein said adaptive interface comprises at least one positive male terminal, at least one negative male terminal, and at least one male ground terminal enabled to couple said plurality of electrical receptacles to said standard electrical outlet.

10. An apparatus comprising:
a plurality of receptacles, said plurality of receptacles being oriented so as to enable a brick plug assembly to be electrically engaged with each of said plurality of receptacles at once.

11. The apparatus of claim 10 wherein each of said plurality of receptacles comprises at least one female ground terminal and a pair of female positive and negative terminals.

12. The apparatus of claim 11 wherein said plurality of said electrical receptacles are oriented such that each of said at least one female ground terminal is located outside of an area between said female positive and negative terminal pairs of said plurality of electrical receptacles.

13. The apparatus of claim 10 wherein at least two of said plurality of elecrical receptacles are oriented in opposite directions of each other.

14. The apparatus of claim 12 further comprising an adaptive interface being enabled to electrically engage a standard electrical outlet.

15. The apparatus of claim 14 further comprising a housing, said housing being enabled to electrically isolate said plurality of receptacles and said adaptive interface such that said apparatus is compliant with common consumer or commercial safety standards.

16. The apparatus of claim 15 wherein said adaptive interface is positioned on an opposite side of said housing from said plurality of receptacles so as to enable said plurality of receptacles to be electrically engaged with at least one electrical plug assembly when said adaptive interface is electrically engaged with said standard electrical outlet.

17. A system comprising:
at least one multi-receptacle adapter comprising a plurality of electrical receptacles, said electrical receptacles being oriented so as to enable a brick plug assembly to be electrically engaged with each of said plurality of receptacles at once;
at least one standard electrical wall outlet, said at least one standard electrical wall outlet comprising at least one electrical receptacle capable of being electrically engaged with said multi-receptacle adapter.

18. The system of claim 17 wherein said plurality of electrical receptacles comprises at least one female ground terminal and at least one female positive and negative terminal pair.

19. The system of claim 18 wherein said plurality of said electrical receptacles are oriented such that each of said at least one female ground terminal is located outside of an area between each of said at least one female positive and negative terminal pair.

20. The system of claim 19 further comprising a housing, said housing enabled to electrically isolate said plurality of receptacles and said adaptive interface such that said apparatus is compliant with common consumer or commercial safety standards.

21. The system of claim 20 wherein said adaptive interface is positioned on an opposite side of said housing from said plurality of receptacles so as to enable said plurality of receptacles to be electrically engaged with at least one electrical plug assembly when said adaptive interface is electrically engaged with said standard electrical outlet.

22. The system of claim 21 wherein said at least one multi-receptacle adapter and said at least one standard electrical wall outlet each comprise at least one positive female terminal, at least one negative female terminal, and at least one female ground terminal.

23. The system of claim 22 wherein said at least one multi-receptacle adapter further comprises at least one positive male terminal, at least one negative male terminal, and at least one male ground terminal.

24. A method comprising:
coupling a plurality of brick plug assemblies to a plurality of electrical receptacles, wherein each of said plurality of electrical receptacles is electrically engaged with said plurality of brick plug assemblies at once, each of said plurality of receptacles being oriented in a direction opposite that of at least one other of said plurality of receptacles.

25. The method of claim 24 wherein said plurality of receptacles is electrically isolated by a housing, said housing electrically isolating said receptacles so as to be compliant with common commercial or residential safety standards.

26. The method of claim 25 wherein each of said plurality of receptacles comprises at least one pair of female positive and negative terminals.

27. The method of claim 26 wherein each of said plurality of receptacles further comprises at least one female ground terminal.

28. The method of claim 27 wherein said plurality of said electrical receptacles are oriented such that each of said at least one female ground terminal is located outside of an area between said female positive and negative terminal pairs of said plurality of electrical receptacles.

29. The method of claim 24 wherein said plurality of electrical receptacles are contained within an adaptive interface, said adaptive interface being enabled to couple a plurality of brick plug assemblies to a standard wall electrical outlet.

30. The method of claim 29 wherein said adaptive interface comprises at least one positive and negative male terminal pair.
